(19) United States
(12) Patent Application Publication
(10) Pub. No.: US 2013/0166801 A1
(43) Pub. Date: Jun. 27, 2013

(54) BUS BRIDGE APPARATUS

(71) Applicants: Ik Jae Jae CHUN, Daejeon (KR); Chun-Gi LYUH, Daejeon (KR); Jung Hee SUK, Daejeon (KR); Sanghun YOON, Daejeon (KR); Tae Moon ROH, Daejeon (KR)

(72) Inventors: Ik Jae Jae CHUN, Daejeon (KR); Chun-Gi LYUH, Daejeon (KR); Jung Hee SUK, Daejeon (KR); Sanghun YOON, Daejeon (KR); Tae Moon ROH, Daejeon (KR)

(73) Assignee: Electronics and Telecommunications Research Institute, Daejeon (KR)

(21) Appl. No.: 13/620,294

(22) Filed: Sep. 14, 2012

(30) Foreign Application Priority Data
Dec. 21, 2011 (KR) 10-2011-0139202

(51) Int. Cl. G06F 13/40

(52) U.S. Cl. 710/110

(57) ABSTRACT

Disclosed is a bus bridge apparatus may prevent a transfer performance from being lowered due to bus protocol performance mismatch between interconnections. The bus bridge apparatus is used to transfer data to a slave device of a network-based interconnection from a master device of a bus-based interconnection, data of the master device may be buffered by an internal buffer, and may then be transferred to the slave device. At this time, lowering of a transfer efficiency may be prevented by converting a transfer timing of addresses and data to be optimized to a transfer protocol of the network-based interconnection through a protocol converter.

### CROSS-REFERENCE TO RELATED APPLICATIONS

A claim for priority under 35 U.S.C. §119 is made to Korean Patent Application No. 10-2011-0139202 filed Dec. 21, 2011, in the Korean Intellectual Property Office, the entire contents of which are hereby incorporated by reference.

### BACKGROUND

The inventive concepts described herein relate to a data transmission system, and more particularly, relate to a bus bridge apparatus for connection between heterogeneous interconnections.

Upon designing of System on a Chip (hereinafter, referred to as SoC), various function blocks or Intellectual Properties (IPs) may be united. Interconnection within the SoC may be implemented to provide effective transfer paths and transfer performance among various devices. A plurality of masters including a processor may use interconnection to access different devices.

The most common structure of interconnection may be bus-based interconnection. The bus-based interconnection may be formed of a common bus for data transfer between a master and a slave and an arbiter for a plurality of masters. The bus-based interconnection may use an arbiter when a plurality of masters constituting the SoC simultaneously uses one common bus. Masters receiving a grant signal for the common bus from an arbiter may transfer data to a slave or read data from a slave using the common bus in order.

The bus-based interconnection may have been changed into high-performance and high-efficiency interconnection to solve its low transfer efficiency and performance. For example, the high-performance and high-efficiency interconnection may include AXI introduced by the ARM Ltd. The AXI may be regarded as the architecture that a network protocol is added to a bus-based transfer protocol. The AXI may provide higher transfer efficiency and performance than the bus-based interconnection.

Various devices of the SoC may transmit and receive data through connection with interconnection. Various types of interconnection may be used due to various factors such as device properties, development of interfaces for connection with interconnection, and the like. The SoC using heterogeneous interconnections may need a bus bridge apparatus for connection between interconnection supporting different protocols.

A bus bridge apparatus may provide connection between different bus architectures, and may improve the system performance by expanding the number of bus dependent IP cores being supported. Also, the bus bridge apparatus may reduce a collision traffic amount by partitioning data buses. Also, the bus bridge apparatus may provide a supplementary function for confirming a function of granting or refusing completion of operation. Also, the bus bridge apparatus may provide a supplementary function such as address reapportionment or rearrangement during operation.

A transfer performance of a transfer port may be lowered if a transfer is not performed in light of a property of interconnection upon connection of heterogeneous interconnections through a bus bridge.

### SUMMARY

One aspect of embodiments of the inventive concept is directed to provide a bus bridge apparatus comprising a slave port which interfaces with a master device of a bus-based interconnection, receives read and write transfer command, address data, and write data from the master device, and transfers read data to the master device; a command controller which receives the transfer command; an address buffer which stores the address data; a write data buffer which stores the write data; a read data buffer which stores the read data; a protocol converter which interfaces with a slave device of a network-based interconnection, outputs write data of the master device to the slave device using the address data and the write data at the write transfer command, and receives read data from the slave device at the read transfer command; and a transfer mode controller which operates at read and write modes according to the transfer command under a control of the command controller and controls outputs of the address, read, and write buffers to transfer the read and write data.

In example embodiments, the slave port provides the command controller with command information associated with read and write transfer commands, a burst type, and a data transfer size received from the master device.

In example embodiments, the command controller provides the transfer mode controller and the protocol converter with the command information associated with the read and write transfer commands, the burst type, and the data transfer size to transfer the read and write data.

In example embodiments, the slave port continuously stores address data and write data corresponding to a transfer command at the address buffer and the write data buffer by a burst mode unit, respectively.

In example embodiments, the protocol converter converts a protocol of the write data to correspond to a protocol of a network-based interconnection.

In example embodiments, the protocol converter operates as a master port.

In example embodiments, the slave port provides the command controller with a read transfer command received from the master device.

In example embodiments, the bus bridge apparatus further comprises a read buffer which stores read data corresponding to the read command.

In example embodiments, the command controller controls the transfer mode controller according to the read transfer command to operate at a read mode. When read data received from a slave device corresponding to the read transfer command is stored at the read data buffer, the command controller controls the read data buffer to be output to a master device through the slave port.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a connection structure using a bride between a bus-based interconnection and a network-based interconnection.

FIG. 2 is a timing diagram illustrating a data write transfer from a master device having a bus-based interface to a slave device having a network-based interface through a general bridge.

FIG. 3 is a block diagram schematically illustrating a bus bridge apparatus according to an embodiment of the inventive concept.

FIG. 4 is a timing diagram illustrating a data write transfer from a master device having a bus-based interconnection to a slave device having a network-based interconnection according to a use of a bus bridge apparatus of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

The inventive concept is related to a bridge apparatus connecting heterogeneous interconnections. The inventive concept may improve a data transfer performance from a master device, connected with a bus interconnection, to a slave device connected with a network interconnection. The inventive concept will be described under the assumption that a bus-based interconnection is AHB introduced by the ARM Ltd. and a network-based interconnection is AXI introduced by the ARM Ltd. However, the inventive concept may be applied to bridge apparatus connecting another bus-based interconnection and another network-based interconnection.

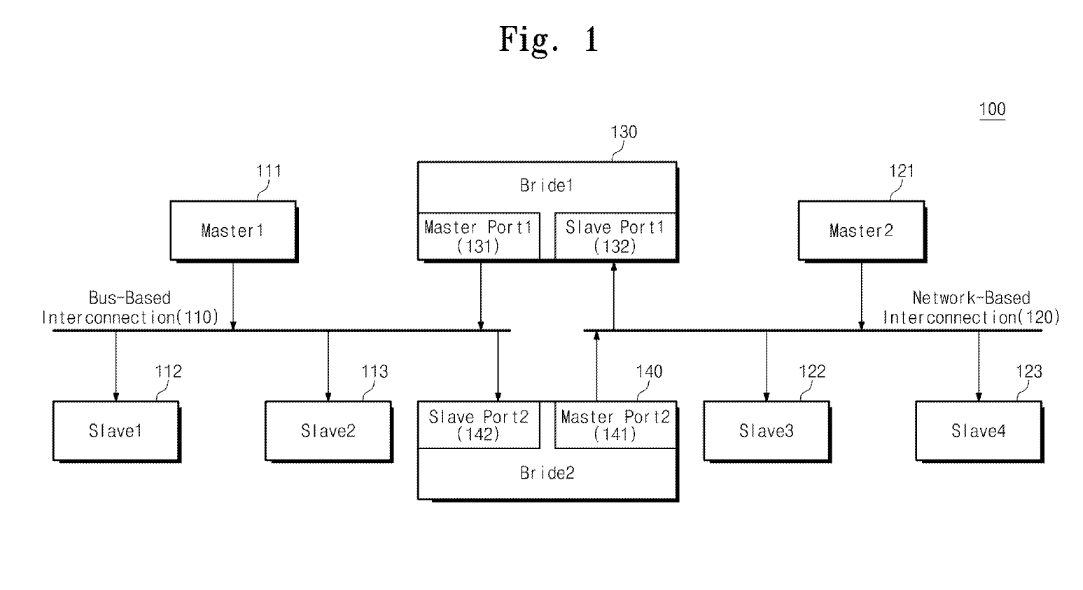

FIG. 1 is a block diagram schematically illustrating a connection structure using a bride between a bus-based interconnection and a network-based interconnection.

Referring to FIG. 1, there may be illustrated a bus-based interconnection 110 and a network-based interconnection 120. The bus-based interconnection 110 may be connected with a first master 111, a first slave 112, and a second slave 113. The network-based interconnection 120 may be connected with a second master 121, a third slave 122, and a fourth slave 123.

IP devices 111 to 113 supporting the bus-based interconnection 110 and IP devices 121 to 123 supporting the network-based interconnection 120 may be interconnected through a first bridge apparatus 130 and a second bridge apparatus 140.

The bus bridges 130 and 140 may be used to connect heterogeneous interconnections 110 and 120.

The first bridge apparatus 130 may include a first master port 131 being a bus interface of a master function and a first slave port 132 being a network interface of a slave function. The second bridge apparatus 140 may include a second master port 141 being a bus interface of a master function and a second slave port 142 being a bus interface of a slave function.

There will be described the case that the first master device 111 connected with the bus-based interconnection 110 transfers data to the third slave device 122 connected with the network-based interconnection 120. In a transfer path of access information, access information of the first master device 111 may be sent to the second slave port 142 of the second bridge apparatus 140. The access information transferred to the second slave port 142 may be transmitted to the third slave 122 connected with the network-based interconnection 120 through the second master port 141.

There will be described the case that the second master device 121 connected with the network-based interconnection 120 transfers data to the first slave device 112 connected with the bus-based interconnection 110. In a transfer path of access information, access information of the second master device 121 may be sent to the first slave port 132 of the first bridge apparatus 130. The access information transferred to the first slave port 132 may be transmitted to the first slave 112 connected with the bus-based interconnection 110 through the first master port 131.

The network-based interconnection 120 may provide a higher transfer performance than the bus-based interconnection 110. A data transfer performance between heterogeneous interconnections may depend on a performance of the bus-based interconnection 110. In the event that data is transferred from the second master device 121 connected with the network-based interconnection 120 to a slave device 112 or 113 connected with the bus-based interconnection 110, a data transfer performance may depend on a bus performance.

In the event that data is transferred from the first master device 111 connected with the bus-based interconnection 110 to a slave device 122 or 123 connected with the network-based interconnection 120, a data transfer performance may lower a bus performance of a network-based interface due to a property of a bus protocol.

A data transfer may be performed as the following order. A master device may conduct a bus permission request to an arbiter, request a data transfer command of a slave device, and receive a data transfer complete response according to command execution of the slave device.

A data transfer of the bus-based interconnection 110 is as follows. Masters devices connected with the bus-based interconnection 110 may not use a bus at the same time, and when one master device uses a bus, another master device may wait until a bus permission is granted. At this time, a data transfer may be completed when a slave device transfers a response signal to a data transfer request of a master device. Herein, another data transfer may not be performed before a data transfer is completed.

A data transfer of the network-based interconnection 120 is as follows. The network-based interconnection 120 may have a structure that a read channel and a write channel are separated. Master devices of the network-based interconnection 120 may perform a read operation and a write operation at the same time. Since a data transfer request of another master device is performed independently, it may conduct a data transfer request although an operation on a data transfer request is not completed.

A bus bridge apparatus using the above-described property of the network-based interconnection 120 may secure continuity of a data transfer and improve a transfer performance. For example, when a master device accesses a memory device (i.e., a slave device), the memory device may prepare data for a next transfer if an address for the next transfer is previously received. But, due to a bus protocol property of the bus-based interconnection 110, an address for a next transfer may be transferred after a data transfer being currently performed is ended. This may make a data transfer performance lowered. On the other hand, in case of the network-based interconnection 120, since an address for a next transfer is transferred to a memory device during a data transfer operation, a transfer performance improvement may be performed.

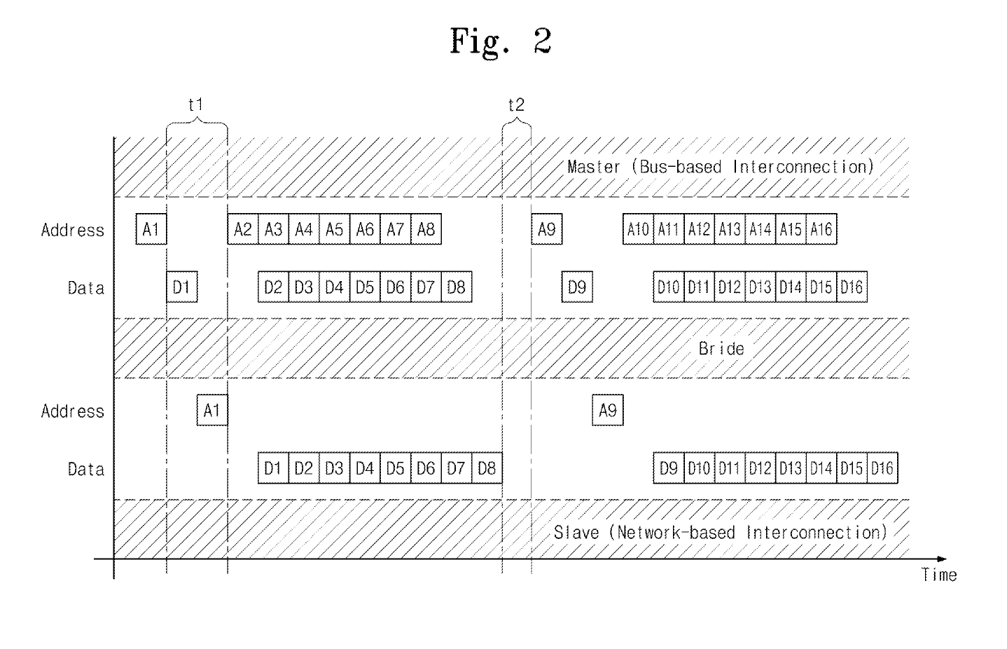

FIG. 2 is a timing diagram illustrating a data write transfer from a master device having a bus-based interface to a slave device having a network-based interface through a general bridge.

Referring to FIG. 2, there may be illustrated a transfer timing according to a bridge use in a data write transfer from a master device having a bus-based interface to a slave device having a network-based interface through a general bridge. Herein, a burst mode of ‘8’ may be used.

If a data transfer is requested by a first master device 111, a start address of A1 may be sent to a third slave device 122 through a second bridge apparatus 140. At this time, a slave device may transfer a signal on a ready state ready to receive an address on an input start address. The first master device 111 may start to transfer data in response to the ready signal.

When data is transferred between the first master device 111 and the third slave device 122, a delay time t1 from a time when a start address is sent to the third slave device 122 until a time when a response is received and a delay time t2 from a time when a data reception completion response of the third slave device 122 is sent until a next transfer of the first master device 111 may be generated.

With the above description, a transfer performance may be lowered due to mismatch between network protocols.

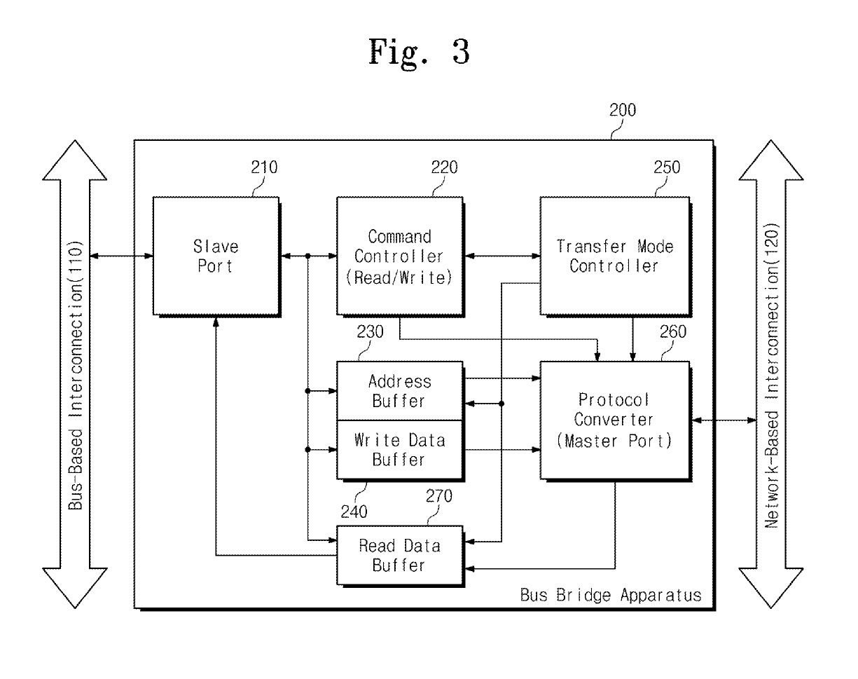

FIG. 3 is a block diagram schematically illustrating a bus bridge apparatus according to an embodiment of the inventive concept.

Referring to FIG. 3, a bus bridge apparatus 200 may be located between a bus of a bus-based interconnection 110 and a bus of a network-based interconnection 120. The bus bridge apparatus 200 may include a slave port 210, a command controller 220, an address buffer 230, a write data buffer 240, a transfer mode controller 250, a protocol converter 260, and a read data buffer 270.

The slave port 210 may be configured to interface with master devices (e.g., a first master device 111) of the bus-based interconnection 110. The slave port 210 may receive a read transfer command, a write transfer command, a transfer address, and write data from the master device. The slave port 210 may receive command information for a data transfer. Herein, command information may include information associated with a burst manner, a data size, and the like.

The slave port 210 may output the read transfer command and the write transfer command to the command controller 220. The slave port 210 may output the input command information to the command controller 220. The slave port 210 may store the transfer address at the address buffer 230. The slave port 210 may store the write data at the write data buffer 240. That is, the slave port 210 may continuously store the address data and the write data corresponding to the transfer command at the address buffer 230 and the write data buffer 240 by a predetermined unit, for example, a burst mode unit, respectively.

The slave port 210 may request a response wait of the first master device at the same time when the read transfer command is received. Upon receiving of the read transfer command, the slave port 210 may transfer read data received from the read data buffer 270 to the first master device 111.

The command controller 220 may receive the transfer command and the read transfer command transferred from the first master device 111 through the slave port 210. The command controller 220 may receive command information such as a data transfer size, a burst type (or, a burst mode), and the like from the first master device 111. The command controller 220 may provide the transfer mode controller 250 and the protocol converter 260 with information according to read and write modes using the read and write transfer commands and the command information.

If read data corresponding to a data size requested by the first master device 111 is stored at the read data buffer 270 during a read operation on the third slave device 122, the command controller 220 may request a completion operation on the read transfer command of the transfer mode controller 250.

The address buffer 230 may store transfer addresses for transferring data to the third slave device 122.

The write data buffer 240 may store write data to be provided to the third slave device 122 of the network-based interconnection 120 from the first master device 111 of the bus-based interconnection 110.

The transfer mode controller 250 may control the protocol converter 260 using read/write mode information provided from the command controller 220. The transfer mode controller 250 may check a burst type to be sent and data transfer control situation information of the protocol converter 260, and may control a data transfer to the protocol converter 260 by controlling the address buffer 230 and the write data buffer 240. At this time, the transfer mode controller 250 may complete a data transfer operation by communicating with the third slave device 122 of the network-based interconnection 12 using a value of the address buffer 230 and burst type information. Upon a completion operation request on a read transfer command from the command controller 220, the transfer mode controller 250 may control the read data buffer 270 to output data of the third slave device 122 to the slave port 210.

The protocol converter 260 may interface with slave devices (e.g., a third slave device 122) of the network-based interconnection 120. Thus, the protocol converter 260 may act as a master port. The protocol converter 260 may be connected to the network-based interconnection 120 to perform protocol conversion.

At a write operation on the third slave device 122 requested by the first master device 111, the protocol converter 260 may receive a transfer address provided from the address buffer 230 and write data provided from the write data buffer 240.

At a read operation on the third slave device 122 requested by a master device, the protocol converter 260 may provide the third slave device 122 of the network-based interconnection 120 with a burst type, a data transfer size, and address information received from the command controller 220 and the transfer mode controller 250. The protocol converter 260 may store data received from the third slave device 122 of the network-based interconnection 120 at the read data buffer 270 under the control of the transfer mode controller 250.

Thus, protocol conversion of the protocol converter 260 may mean converting of write data of the bus-based interconnection 110 to correspond to a protocol of the network-based interconnection 120 or converting read data of the network-based interconnection 120 to correspond to a protocol of the bus-based interconnection 110.

The read data buffer 270 may store read data received from a slave device 122 of the network-based interconnection 120 through the protocol converter 260. Read data stored at the read data buffer 270 may be data requested by the first master device 111.

The bus bridge apparatus is described using a data read and/or write operation executed between the first master device 111 and the third slave device 122. However, the inventive concept is not limited thereto. For example, another master device of the bus-based interconnection 110 is used for a read/write operation instead of the first master device 111, or another slave device may be used instead of the third slave device 122 of the network-based interconnection 120.

The bus bridge apparatus 200 of the inventive concept may replace a second bridge apparatus 140 in FIG. 1.

The bus bridge apparatus 200 of the inventive concept may have a structure considering a network protocol property to prevent lowering of a data transfer performance between heterogeneous interconnections. In particular, in the event that the above-described bus bridge apparatus is used to transfer data to a slave device of a network-based interconnection from a master device of a bus-based interconnection, data of the master device may be buffered by an internal buffer, and may then be transferred to the slave device. At this time, lowering of a transfer efficiency may be prevented by converting a transfer timing of addresses and data to be optimized to a transfer protocol of the network-based interconnection through a protocol converter.

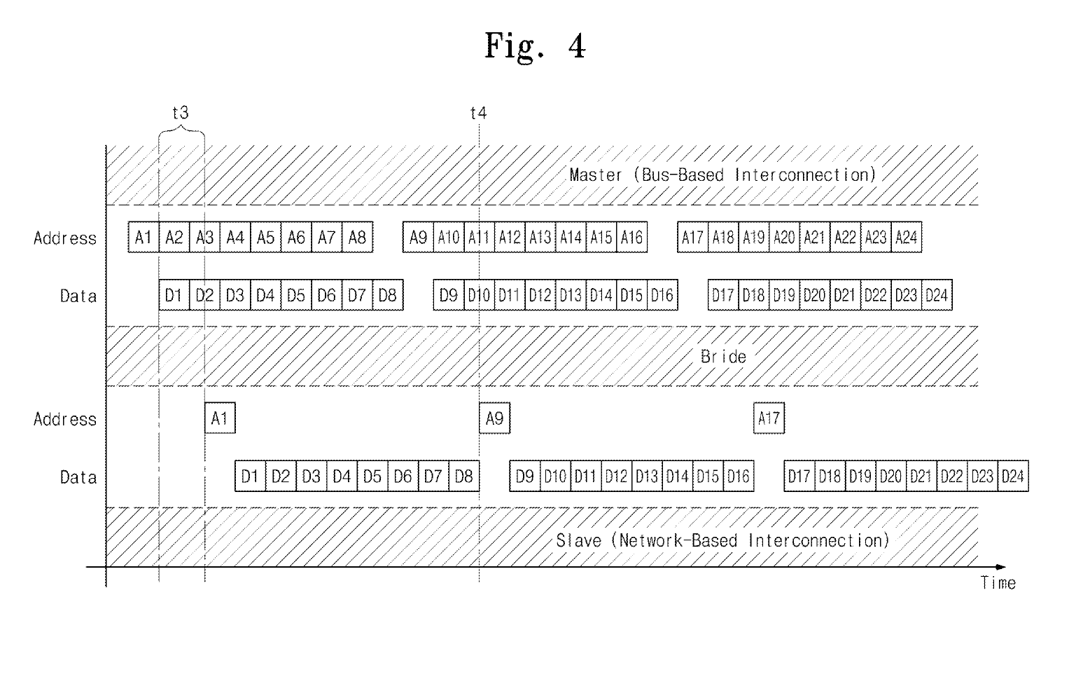

FIG. 4 is a timing diagram illustrating a data write transfer from a master device having a bus-based interconnection to a slave device having a network-based interconnection according to a use of a bus bridge apparatus of the inventive concept.

Referring to FIG. 4, there may be illustrated a transfer timing according to a bridge use in a data write transfer from a first master device 111 having a bus-based interconnection 110 to a third slave device 122 having a network-based interconnection 120. Herein, a burst mode of ‘8’ may be used.

If a data transfer is requested by a first master device 111, a start address of A1 may be sent to a third slave device 122 through a second bridge apparatus 200. At this time, the second bridge apparatus 200 may store an address and data at an address buffer and a write data buffer without transferring of data to the third slave device 122, and may transfer data independently from the third slave device 122. Thus, the first master device 111 may transfer data according to a state of the second bridge apparatus 200, not be connected directly with the third slave device 122.

After storing of address and write data between the first master device 111 and the second bridge apparatus 200 commences, data may be transferred between the second bridge apparatus 200 and the third slave device 122 independently. At this time, at a data transfer between the first master device 111 and the third slave device 122, there may be generated a delay time t3 from a time when a start address is sent to the third slave device 122 through the second bridge apparatus 200 until a time when the second bridge apparatus 200 receives a response indicating a transfer possibility. However, at a next burst data transfer, next transfer address and write data previously stored at an address buffer 230 and a write data buffer 240 of the second bridge apparatus 200 may be provided to the third slave device 122 in advance. Thus, although the first master device 111 does not receive a data reception completion response of the third slave device 122, a next transfer may be performed. That is, a delay time according to a transfer may be minimized As illustrated in FIG. 4, no delay time t4 may be generated.

The bus bridge apparatus 200 of the inventive concept may be configured to continuously transfer a transfer address and write data by a predetermined unit (e.g., a burst mode unit) through buffers. Thus, it is possible to prevent lowering of a transfer performance according to a data transfer between heterogeneous interconnections.

As described above, the bus bridge apparatus 200 of the inventive concept may prevent a transfer performance from being lowered due to bus protocol performance mismatch between interconnections. In particular, the bus bridge apparatus 200 may improve a data transfer to a slave device of a network-based interconnection from a master device of a bus-based interconnection experiencing lowering of performance larger than the network-based interconnection.

The SoC may use various interconnections such as AHB, AXI, coreconnect, and the like, and may transmit and receive data using different communication protocols. Also, IP devices of the SoC may provide different interfaces for connected with interconnection, respectively. For example, in case of an AMBA bus introduced by the ARM Ltd. bus-based interconnections such as AHB and APB and a network-based interconnection such as AXI may exist. Also, IP devices may support different interconnections according their properties. The SoC supporting different interconnections may use a bus bridge apparatus for connection between interconnections. In this case, a performance of the bus bridge apparatus may be based on a data transfer performance.

In the event that a master device connected with a bus-based interconnection accesses a slave device (e.g., a memory) connected with a network-based interconnection, a performance of the network-based interconnection providing a high transfer performance may be maximized.

The bus bridge apparatus of the inventive concept may maximize a transfer efficiency of a transfer channel of a network-based interconnection by corresponding to an access request to a slave device, connected with a network-based interconnection, from a master device through an independent bus interface module and separating a transfer control operation on data to be transferred from a transfer control operation of a bus-based interconnection.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A bus bridge apparatus comprising:
a slave port which interfaces with a master device of a bus-based interconnection, receives read and write transfer command, address data, and write data from the master device, and transfers read data to the master device;
a command controller which receives the transfer command;
an address buffer which stores the address data;
a write data buffer which stores the write data;
a read data buffer which stores the read data;
a protocol converter which interfaces with a slave device of a network-based interconnection, outputs write data of the master device to the slave device using the address data and the write data at the write transfer command, and receives read data from the slave device at the read transfer command; and
a transfer mode controller which operates at read and write modes according to the transfer command under a control of the command controller and controls outputs of the address, read, and write buffers to transfer the read and write data.

2. The bus bridge apparatus of claim 1, wherein the slave port provides the command controller with command information associated with read and write transfer commands, a burst type, and a data transfer size received from the master device.

3. The bus bridge apparatus of claim 2, wherein the command controller provides the transfer mode controller and the protocol converter with the command information associated with the read and write transfer commands, the burst type, and the data transfer size to transfer the read and write data.

4. The bus bridge apparatus of claim 1, wherein the slave port continuously stores address data and write data corresponding to a transfer command at the address buffer and the write data buffer by a burst mode unit, respectively.

5. The bus bridge apparatus of claim 1, wherein the protocol converter converts a protocol of the write data to correspond to a protocol of a network-based interconnection.

6. The bus bridge apparatus of claim 1, wherein the protocol converter operates as a master port.

7. The bus bridge apparatus of claim 1, wherein the slave port provides the command controller with a read transfer command received from the master device.

8. The bus bridge apparatus of claim 7, further comprising:
a read buffer which stores read data corresponding to the read command.

9. The bus bridge apparatus of claim 1, wherein the command controller controls the transfer mode controller according to the read transfer command to operate at a read mode, and
wherein when read data received from a slave device corresponding to the read transfer command is stored at the read data buffer, the command controller controls the read data buffer to be output to a master device through the slave port.
